(19) United States
(12) Patent Application Publication
(10) Pub. No.: US 2006/0126102 A1
(43) Pub. Date: Jun. 15, 2006

(54) Print system

(75) Inventor: Kenji Sakuda, NAGANO-KEN (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION, TOKYO (JP)

(21) Appl. No.: 10/522,313

(22) PCT Filed: Jul. 28, 2003
(86) PCT No.: PCT/JP03/09510

§ 371 Date: Oct. 24, 2005

(30) Foreign Application Priority Data
Jul. 26, 2002 (JP) 2002-218172

(51) Int. Cl. G06F 3/12

(52) U.S. Cl. 358/1.15

(57) ABSTRACT

It is an object of the present invention, e.g., where image file(s) are sent directly to printer(s) from digital camera(s) or other such peripheral equipment and printing of same is automatically carried out thereat, to cause interruption of printing in units of page(s) during battery consumption and to prevent occurrence of wasted printed output.

Camera 10 and printer 20 support DPOF printing, it being possible to instruct printer 20 to print image file(s) from camera 10 without use of an intervening personal computer or the like. Camera 10 issues print cancellation(s) upon determining that continuation of printing has, due to consumption of internal battery 18, become impossible. Printer 20 interrupts current printing session(s) at location(s) serving as convenient division(s) (i.e., in units of page(s) and/or object(s)), and communicates job status information to camera 10. During resumption of printing, job status information and DPOF script file(s) are sent from camera 10 to printer 20, and printing resumes from unprinted portion(s).

### FIELD OF ART

The present invention pertains to a printing system; e.g., a printing system that sends a plurality of image files or the like from digital camera(s) or other such host apparatus(es) to printer(s) so as to allow them to be printed thereat.

### TECHNICAL BACKGROUND

Accompanying developments in digital image technology and microcomputer systems, digital cameras and similar devices which capture images have come into widespread use. While images captured with digital cameras can be viewed using an internal display screen or an external display screen connected thereto, it is also frequently the case that printed output is generated therefrom. Where printed output is to be generated from images captured with a digital camera, this might be accomplished by first transferring image file(s) from the digital camera to a personal computer and then sending same from the personal computer to a printer.

However, because carrying out printing by way of personal computer is time-consuming and represents an inconvenience to the user, direct printing, wherein image file(s) are sent directly from the digital camera to the printer and are printed, has been proposed. However, because image file(s) are exchanged between or among peripheral devices with no personal computer(s) intervening therebetween, specification of image(s) to be printed and/or number of sheets or copies, as well as image rotation, enlargement/reduction, and various other settings, has in the case of conventional direct printing been troublesome.

In recent years, standards such as DCF (Design rule for Camera File system) and DPOF (Digital Print Order Format) have therefore been defined, making it possible for automatic direct printing to be carried out in all the more simple fashion as a result of prestorage within digital camera recording media (memory card(s) or the like) of captured image file(s) and image file print specification information.

With DPOF, because file(s) for requesting printing from printer(s) are stored on recording media in linked fashion with image file(s), a user can cause printing of desired image(s) to be carried out at specified conditions merely by establishing a direct connection between the digital camera and the printer and sending image file(s) and print specification file(s) to the printer.

However, after the print request has been sent from the digital camera, because all printing processing is carried out at the printer, there is no way for the digital camera to know about current print status and so forth. That is, digital cameras used in conventional direct printing do nothing more than issue a print request to the printer, the printing processing occurring thereafter proceeding strictly at the printer; and, there being no way for the digital camera to know how printing is progressing, the digital camera can do nothing but wait until printing at the printer is completed.

Now, digital cameras ordinarily obtain electrical power from internal batteries; e.g., lithium batteries or the like. Furthermore, printers carry out printing in sequential fashion as image file(s) are obtained from digital cameras.

Accordingly, in the event that the charge level of an internal battery decreases to the point where it is no longer capable of sustaining digital camera operations, the digital camera will, regardless of the status of printing at the printer, request that the printer cancel printing and will turn off power and enter a standby state. As a result of this emergency request to cancel printing, it may for example happen that the printer terminates printing partway through a page, or where a single page contains a plurality of image files it is sometimes the case that processing of image file(s) currently being printed is interrupted. This being the case, printed output goes to waste and there is wasted consumption of printing paper and/or ink.

### DISCLOSURE OF INVENTION

The present invention was conceived in light of the foregoing problems, it being an object thereof to provide a printing system making it possible to prevent waste of printing resources as a result of causing printing to be canceled in units of page(s) in the event of cancellation of printing.

In order to solve one or more of the foregoing problems, a printing system associated with one aspect of the present invention comprises a host apparatus creating print data and a printer carrying out printing, print data being obtained from the host apparatus; and furthermore comprises cancellation means and print control means.

Cancellation means may request cancellation of printing in units of page(s) from printer(s). In addition, print control means may, in the event of cancellation of printing, cause printing to continue until printing of a page currently being printed is completed, and in the event that there is or are subsequent page(s), interrupt printing of anything subsequent thereto. That is, print control means may, in the event of cancellation of printing, cause printing to be interrupted in units of page(s). As a specific example, in the event that there is a request for print cancellation during printing of a one-page print job, print control means may cause printing processing to terminate after the page which is currently being printed has been printed. In the event that there is a request for print cancellation during printing of a print job containing a plurality of pages, print control means may cause the page which was being printed at the point in time when print cancellation was requested to be printed until it is finished, and then cancel printing processing for other page(s) subsequent thereto. Accordingly, where a print job containing a plurality of pages is being printed (or more accurately, in the event that any page but the last page in a print job containing a plurality of pages is being printed), print control means may, upon receipt of a request for print cancellation, cause printing of the page currently being printed to be completed and then cancel subsequent printing. This makes it possible to prevent waste of printing resources.

Personal computer(s), mobile phone(s), portable information terminal(s), digital camera(s), digital video camera(s), scanning equipment, and the like may be cited as examples of host apparatus(es). The term “host” is used here with reference to creation of print data, and need not coincide with the concept of “host” in the context of data communication. For example, taking the case where print data is sent via USB connection, in one possible configuration a digital camera might serve as USB device while a printer serves as USB host, print data (image file(s)) stored within the digital camera being obtained when the printer acts as host.

As the printer might be such as to permit printing to be carried out while print job data is being obtained from the host apparatus, a serial printer or the like could serve as such a printer. That is, it is possible to use a serial printer such as one that, instead of carrying out printing only after first storing all of the print data in advance in storage device(s) within the printer, carries out printing in sequential fashion by creating image data in units of bands from as much print data as has been received.

In one embodiment, interruption prediction capability capable of determining whether printing interruption event(s) is or are expected to occur at host apparatus(es) may be provided. A “printing interruption event” at a host apparatus refers to a situation in which continuation of printing by a printer is impossible; as examples of which, insufficient supply of electrical power to host apparatus due to consumption of internal battery or the like, inability to carry out data communication due to failure of data communication cable or the like, a print cancellation instruction by a user, and the like may be cited.

Moreover, both print data and interruption location information indicating page location(s) at which printing was or will be interrupted may be stored at host apparatus(es). Alternatively, interruption location information might be stored at printer(s), and when host apparatus recharging is complete or resumption of printing has otherwise become possible, interruption location information might be sent from printer to host apparatus.

For example, storage of print data and interruption location information at internal and/or external storage device(s) provided at host apparatus(es) would make it possible cause resumption of printing at other printer(s). For example, where printing is temporarily interrupted because of some urgent matter or consumption of internal battery during printing at initial printer(s), notwithstanding that processing may thereafter have been moved to different location(s), by connecting host apparatus(es) to different printer(s) of the same type, it may be possible to resume printing. Print data and interruption location information need not be stored at the same storage device. For example, interruption location information might be stored in nonvolatile memory at a host apparatus, and print data might be stored in a removably installable external storage device provided at the host apparatus. If both print data and interruption location information are, for example, stored on hard disk drive device(s), memory card(s), PC card(s), and/or other such storage medium or media capable of being connected to host apparatus(es), it will also be possible by connecting such recording medium or media to other host apparatus(es) to cause printing to be resumed by way of the other host apparatus(es).

In creating image data in units of bands based on print data obtained from host apparatus(es), printer(s) might, for example, carry out color conversion processing, halftoning processing, and/or other such prescribed image processing. “Bands” refer to strip-like regions into which a page is divided in the paper feed direction. Image data in units of bands might be printed on printing paper by a printer during the course of a single scan-direction scan or multiple scan-direction scans. In the event of request(s) for print cancellation from host apparatus(s) during printing, printer print control means may cause printing processing to continue until printing of page(s) currently being printed has been completed, and may cancel subsequent printing following conclusion of printing of page(s) currently being printed.

In accordance with another aspect of the present invention, printing method(s) such as might be carried out by printing system(s) as described above is/are provided.

In accordance with yet another aspect of the present invention, in the context of a printing system comprising a host apparatus creating print data and a printer obtaining print data from the host apparatus and carrying out printing, in the event that a battery charge level of the host apparatus is less than or equal to a prescribed value,

(1) job status information is stored at the printer;

(2) the battery is recharged using power from the printer;

(3) judgment is made as to whether the battery charge level has recovered to the extent that the prescribed value is exceeded; and

(4) in the event that the battery charge level recovers, the job status information is obtained from the printer and printing is continued.

In accordance with yet another aspect of the present invention, host apparatus(es), printer(s), and/or computer program(s) such as might be employed at printing system(s) as described above is/are provided. Computer program(s) in accordance with the present invention may be distributed in recorded form on any of various recording media including, for example, memory or memories, hard drive(s) and/or hard disk(s) (HD), CD-ROM, DVD-RAM, and so forth; and/or may be distributed electronically via communication network(s).

### BRIEF DESCRIPTION OF DRAWINGS

FIG. 1 is a block diagram showing a schematic overview of a printing system associated with a first embodiment of the present invention.

FIG. 2 contains a diagram illustrating storage hierarchy at a recording medium.

FIG. 3 contains diagrams illustrating (a) DPOF print specification method, and (b) the structure of a DPOF script file that might be created thereby.

FIG. 4 contains diagrams illustrating specific examples of DPOF script files.

FIG. 5 contains emblematic representations showing result of printing such as might occur during normal DPOF printing.

FIG. 6 is a flowchart showing DPOF print instruction processing such as might be executed at a camera.

FIG. 7 is a flowchart showing DPOF printing processing such as might be executed at a printer.

FIG. 8 is a flowchart showing printing interruption processing such as might be executed at a printer.

FIG. 9 is a flowchart showing DPOF print instruction processing such as might take place at a camera associated with a second embodiment of the present invention.

FIG. 10 is a flowchart showing DPOF print instruction processing such as might take place at a camera associated with a third embodiment of the present invention.

FIG. 11 is a flowchart showing print resumption instruction processing.

FIG. 12 contains a diagram illustrating a specific example of a DPOF script file associated with a fourth embodiment of the present invention.

FIG. 13 is a block diagram showing a schematic overview of a printing system associated with a fifth embodiment of the present invention.

FIG. 14 is a flowchart showing processing such as might be executed at a camera.

### BEST MODE FOR CARRYING OUT INVENTION

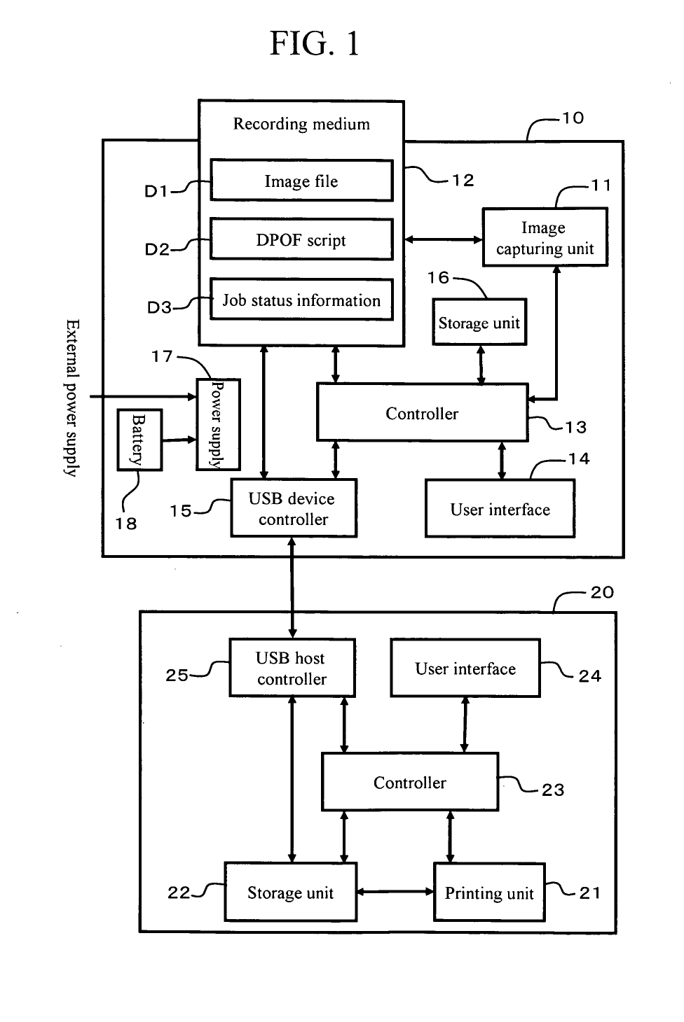

Below, referring to FIGS. 1 through 14, embodiments of the present invention are described in detail.

### 1. First Embodiment

First, referring to FIGS. 1 through 8, a first embodiment of the present invention will be described. FIG. 1 is a block diagram showing a schematic overview of a printing system associated with the present embodiment.

Digital camera (hereinafter abbreviated as “camera”) 10 is, as will be described below, capable of capturing images and storing same as electronic data, and is capable of sending stored image data to printer 20 and causing printing to be carried out. Camera 10 supports the DPOF (Digital Print Order Format) specification. DPOF defines a specification whereby information identifying images selected by a user, the number of sheets or copies to be printed, the manner in which printing is to be carried out, and other such print specification information is saved in a text-based file (DPOF script file); sending of such print specification information to a printer at a lab or to a printer owned by the user which supports DPOF making it possible to carry out automatic printing with no personal computer intervening therebetween.

As will be described below, camera 10 comprises image capturing unit 11, recording medium 12, controller 13, user interface 14, USB device controller 15, storage unit 16, power supply unit 17, and so forth. Image capturing unit 11—comprising, for example, CCD (charge-coupled device) elements, lenses, preprocessing circuitry, and so forth—converts images of photographic subjects into electronic form and outputs same.

Recording medium 12—being, for example, PC card, card-type memory (but note that there is no requirement that recording medium 12 be in the form of card(s)), or other such rewritable recording media—is removably installed at a card slot of camera 10. Recorded on recording medium 12 are file(s) D1 containing image(s) captured by user(s), DPOF script file(s) D2 for making specifications with regard to printing, and job status information D3. Note that it is also possible to adopt a constitution which is such that job status information D3 is stored at storage unit(s) 16 comprising rewritable nonvolatile memory or the like.

A microcomputer system comprising CPU(s), RAM, ROM, and so forth constitutes controller 13, which executes various programs. User interface 14—comprising, for example, liquid crystal display(s), operating switch(es), and/or the like—displays captured images and/or operation menu(s), and moreover, accepts instructions and the like from user(s). USB device controller 15 is for carrying out transfer of data with printer 20 by way of USB cable(s).

Prescribed electrical power is respectively supplied from power supply unit 17 to various components within camera 10 that consume electrical power. Internal battery or batteries 18 and/or external power supply or supplies (e.g., if electrical power is obtained from wall outlet(s) by way of AC/DC converter(s) or the like) serve as source(s) of electrical power for power supply unit 17.

Thus, camera 10 might be capable of being driven by internal battery 18, camera 10 might be connected to printer 20 by way of a USB cable, and image file(s) D1, DPOF script file(s) D2, and job status information D3 might be sent from camera 10 to printer 20, permitting printing to be carried out. Internal battery 18 may, for example, be dry cell(s) and/or may be compact battery or batteries (secondary cell(s)).

Constitution of printer 20 will now be described. Printer 20 comprises printing unit 21, storage unit 22, controller 23, user interface 24, and USB host controller 25, and is configured as a serial color printer with DPOF support.

Printing unit 21 is constituted so as to include print engine(s) and engine controller(s). Printing unit 21 might, for example, carry out processing for conversion of color from RGB color space to CMYK color space, halftoning processing, and/or other such prescribed image processing, and might create image data for printing in units of bands, prescribed printing being carried out in accordance with specified settings as a result of causing printhead(s) to scan in a paper feed direction and in a direction orthogonal thereto. Controller 23—comprising, for example, hard disk drive(s) and/or semiconductor memory device(s)—stores image file(s) and the like acquired from camera 10. User interface 24—comprising, for example, liquid crystal panel(s), operating switch(es), and/or the like—accepts instructions and the like from user(s), and also displays progress of printing and so forth. USB host controller 25 is for carrying out data communication with camera 10 via USB.

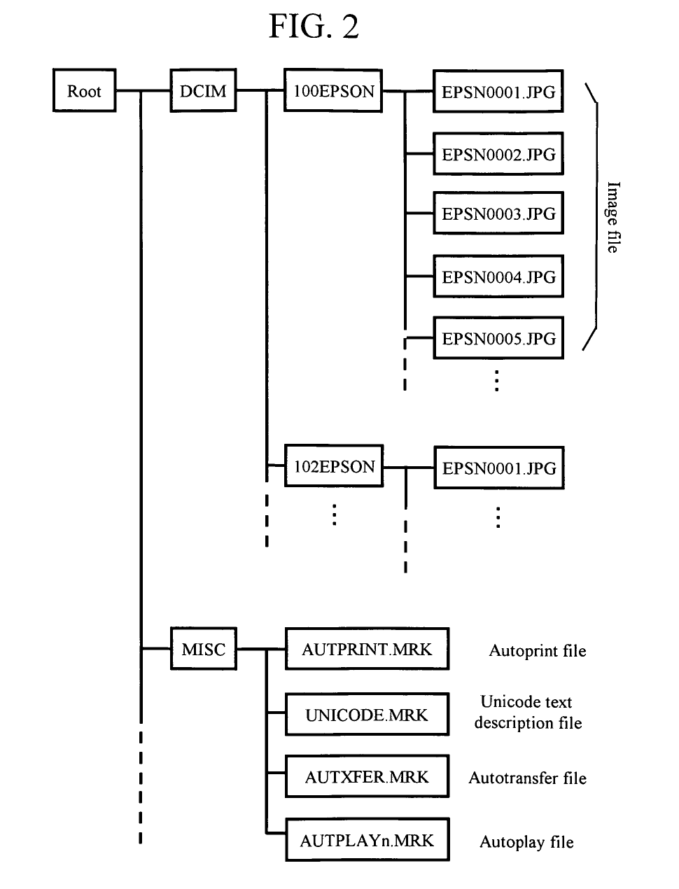

Next, referring to FIG. 2, the storage hierarchy at recording medium 12, which is removably installed at camera 10, will be described.

Formed within root directory or directories (Root) at recording medium or media 12 there might be DCF image directory or directories (DCIM) for still image(s), directory or directories (MISC) for output settings, and so forth; and formed within DCF image directory or directories there might be DCF directory or directories (100EPSON, 102EPSON, etc.) for storing image file(s). In such case, where a plurality of DCF directories are created within a DCF image directory, directory numbers for respective DCF directories are defined in advance so as to avoid repeated use of the same directory number.

Stored within each DCF directory there are one or more captured image files (EPSN0001.JPG, EPSN0002.JPG, etc.). File names of image files stored within respective DCF directories are defined so as to avoid repeated use of a file number within the same DCF directory. But note that there is no objection to repeated use of file numbers for image files across different DCF directories.

Stored within the output settings directory or directories there are autoprint file(s) (AUTPRINT.MRK), Unicode text description file(s) (UNICODE.MRK), autotransfer file(s) (AUTXFER.MRK), and autoplay file(s) (AUTPLAYn.MRK).

Autoprint file(s)—corresponding to DPOF script file(s) D2—are written in text format and contain print instruction(s) necessary for sending image file(s) from camera(s) 10 to printer(s) 20 and for causing printing to be carried out automatically. Moreover, autotransfer files may be used when transferring image(s) via the Internet or other such network, and autoplay files may be used, for example, when viewing a slide show on a projector, television display screen, or the like. Furthermore, Unicode text description files are for permitting use of Unicode so as to accommodate languages of multiple countries.

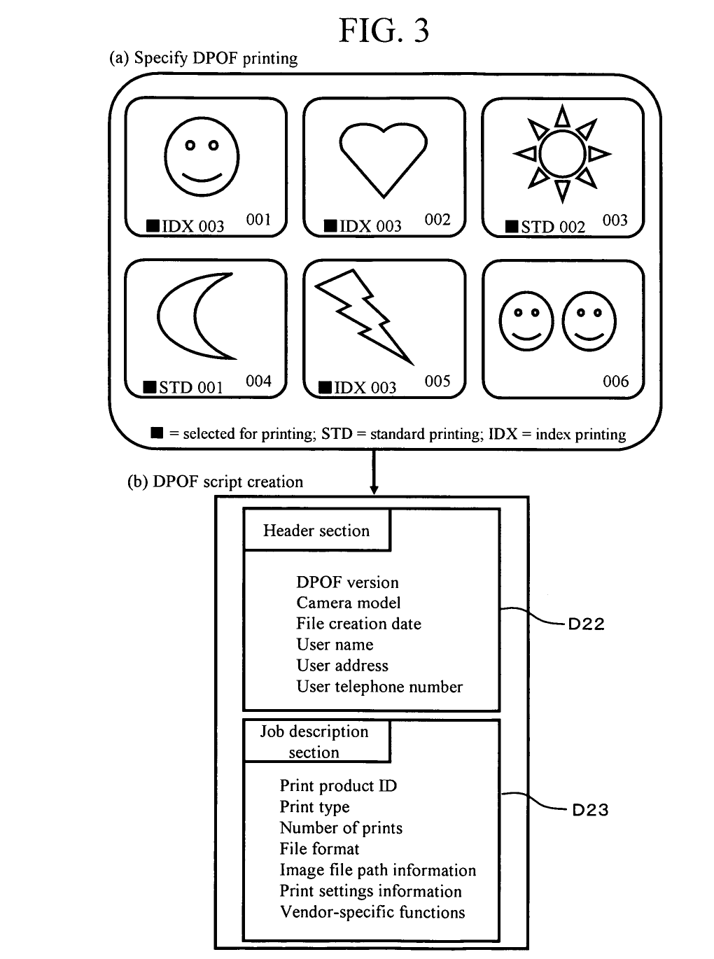

Next, referring to FIG. 3, description is carried out with respect to DPOF print specification(s) and creation of DPOF script file(s) D2.

FIG. 3(a) is an example of a screen that might be displayed at user interface 14 of camera 10, reduced images of respective image files stored at recording medium 12 being displayed in thumbnail fashion. Where DPOF printing is to be carried out, the user selects which image file(s) are to be printed, and also specifies how many sheets or copies are to be printed for each image file, how printing is to be carried out, and so forth. At FIG. 3(a), a black square-shaped mark is displayed at image files selected for printing. Furthermore, standard printing (STD) or index printing (IDX) may be specified as print type(s). The number next to print type indicates the number of sheets or copies to be printed.

When the user has completed making specification(s) with regard to DPOF printing, DPOF script file(s) are created as shown at FIG. 3(b). A DPOF script file can be divided into header section(s) D22 and job description section(s) D23. Header section D22 contains applicable DPOF version number(s), model name(s) of camera(s) 10, DPOF script file creation date(s), and also user information such as user name(s) and/or user address(es) and telephone number(s). Job description section(s) D23 contain print product ID(s), print type(s) (whether to carry out standard printing, index printing, etc.), number(s) of prints, file format(s), image file path information, print settings information (whether to insert date(s), whether to carry out rotation, etc.), vendor-specific function(s) uniquely definable by each camera manufacturer, and so forth. Note that each of the foregoing items may in some cases be required and in some cases be optional.

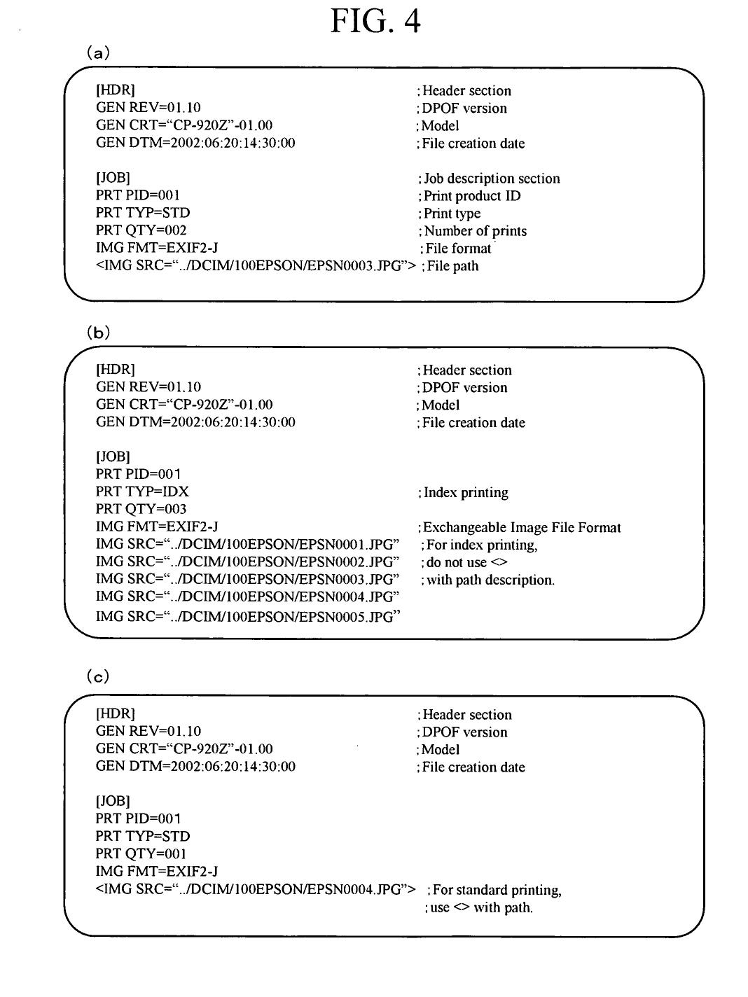

FIG. 4 contains diagrams illustrating specific examples of DPOF script files. As shown in FIG. 4, DPOF script files, created for each individual print job, respectively comprise header section(s) [HDR] and job description section(s) [JOB]. As mentioned with reference to FIG. 3(b), each job description section contains print product ID(s) identifying individual print job(s), print type(s), number(s) of prints, path information for image file(s) to be printed, and so forth; these being written in text format. Accordingly, based on DPOF script file(s), printer(s) 20 can acquire image file(s) to be printed from camera(s) 10 and can carry out printing of acquired image file(s) in accordance with specified method(s). Note that instead of creating a DPOF script file for each individual print job, it is also possible for one DPOF script file to contain descriptions for a plurality of print jobs.

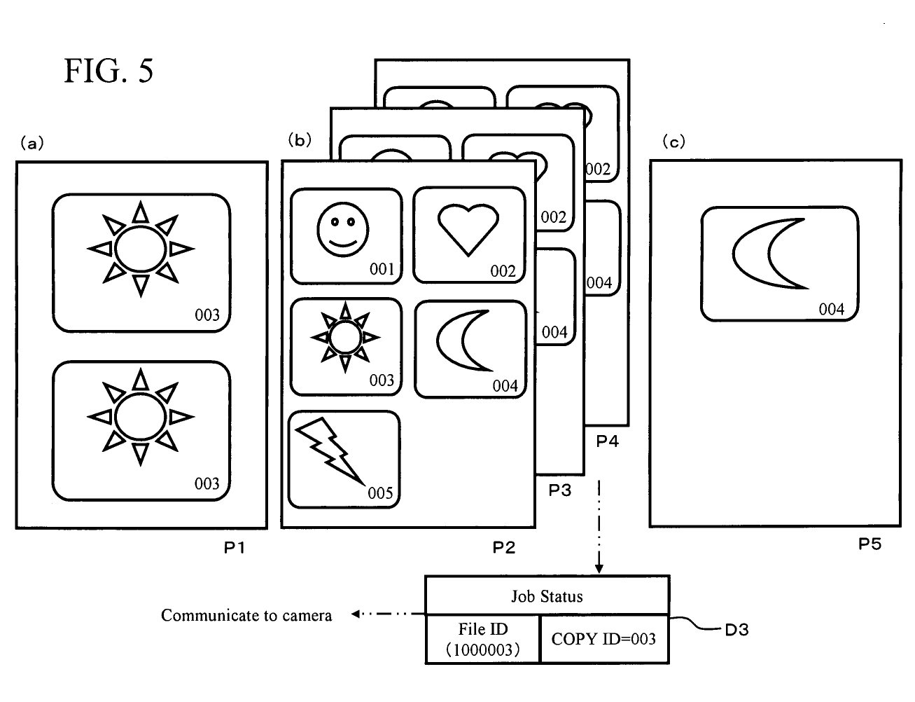

FIG. 5 contains emblematic representations showing a situation such as might exist during normal DPOF printing. The example shown at FIG. 5 indicates a situation that might result when printing is carried out in accordance with the following specifications. Moreover, where standard printing is specified, it will be assumed that as many as two items can be printed on a single sheet of printing paper.

(1) Using standard printing, print two copies of the image file “EPSN003” stored in the directory “100EPSON”;

(2) Using index printing, print three sets of the five image files “EPSN0001” through “EPSN0005”;

(3) Using standard printing, print one copy of the image file “EPSN0004”.

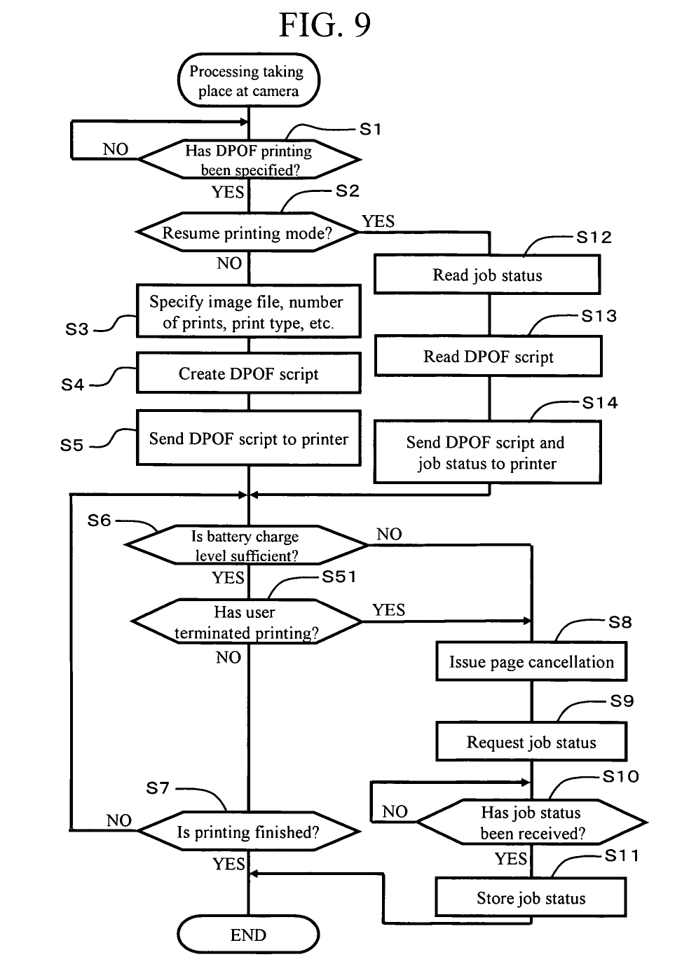

As shown in FIG. 5, two copies of the image file “EPSN003” are printed next to each other on the first page, the image files “EPSN0001” through “EPSN005” are respectively printed in index fashion on the second through fourth pages, and one copy of the image file “EPSN004” is printed on the fifth, or last, page. Note that at FIG. 5, and at FIG. 9 which will be described below, file numbers of image files are for convenience represented by three digits.

When carrying out printing with multiple assignment to each, the manner in which DPOF-specified printing is reflected during printing will depend upon printer settings. For example, at (1), above, printer settings are such as to specify that two images should be assigned to a single sheet of paper. Or at (3), above, printer settings are, like (1), above, such as to specify that two images should be assigned to a single sheet of paper, but because only one image is specified to be printed, an image is assigned only to the top half of the printing paper. But note that the present invention is not limited to situations in which layout during printing is delegated to printer settings, it also being possible to adopt constitutions in which print layout is established based on layout specification information contained within DPOF script file(s) and/or layout specification information separate from DPOF script file(s).

Printer(s) 20 regularly monitor print status(es) at printing unit(s) 21, and create job status information D3 in units of object(s) which is communicated to camera(s) 10. Job status information is made up of information which may, for example, include file ID(s), and/or number(s) of item(s) which have already been printed (COPY ID). Note that print product ID(s) (PRT PID) may also be included within job status information.

File ID(s), being information for identifying image file(s) currently being printed, is/are created so as to be uniquely defined based on image file path information. More specifically, a file ID might be created by concatenating the directory number of the DCF directory in which the image file is stored and the file number of the image file. As described above, DCF directory numbers are established in advance so as to avoid repeated use of directory numbers used for other DCF directories; and moreover, file numbers are established in advance so as to avoid repeated use of a file number within the same DCF directory. Accordingly, as a result of creating the file ID by concatenating the directory number and the file number, it is possible to obtain a number which has a total of seven digits, for which seven bytes of data is sufficient, permitting image file(s) stored on recording medium 12 to be uniquely identified through use of a small amount of information.

If job status information communicated from printer(s) 20 in units of object(s) is saved by camera(s) 10 to recording medium or media 12 and/or storage unit(s) 16, overwriting as necessary, it will be possible to always have the most recent information about how printing is progressing.

Here, in the event of occurrence of error(s) such as depletion of printing paper, depletion of ink, and/or other such consumable(s) which when replenished is/are such as to allow resumption of printing, upon going from state(s) in which replenishment of printing paper and/or ink is being awaited to state(s) in which replenishment has been completed, printer(s) and camera(s) would automatically begin printing. In such a case, because print job(s) would already be stored at printer(s), printing would be continued without the need to send job status information thereto from camera(s) 10. However, in the event of occurrence of error(s) such as, for example, disconnection of power cable(s) and/or USB cable(s), paper jam(s), fatal error(s), and/or other such condition(s) making it impossible to continue printing without intervention, print job(s) would be subject to cancellation (deleted from printer(s)) and printing would be canceled. That is, in the event of minor error(s) permitting easy resumption of printing, job status information would not be sent, printing being immediately resumed following return to state(s) permitting printing; conversely, in the event of serious error(s) precluding immediate resumption of printing, print job(s) would first be deleted, following which job status information would be sent, as a result of which printing could be resumed. Thus, processing in connection with resumption of printing differs in correspondence to the seriousness of the reason for interrupting printing.

In addition, if power cable(s) and/or USB cable(s) become disconnected and/or if printing is interrupted due to occurrence of paper jam(s) and/or the like, it will be possible, by sending the most recent job status information from camera(s) 10 to printer(s) 20, to cause printing to resume from object(s) (image file(s)) which was or were being processed at the time(s) that printing was interrupted.

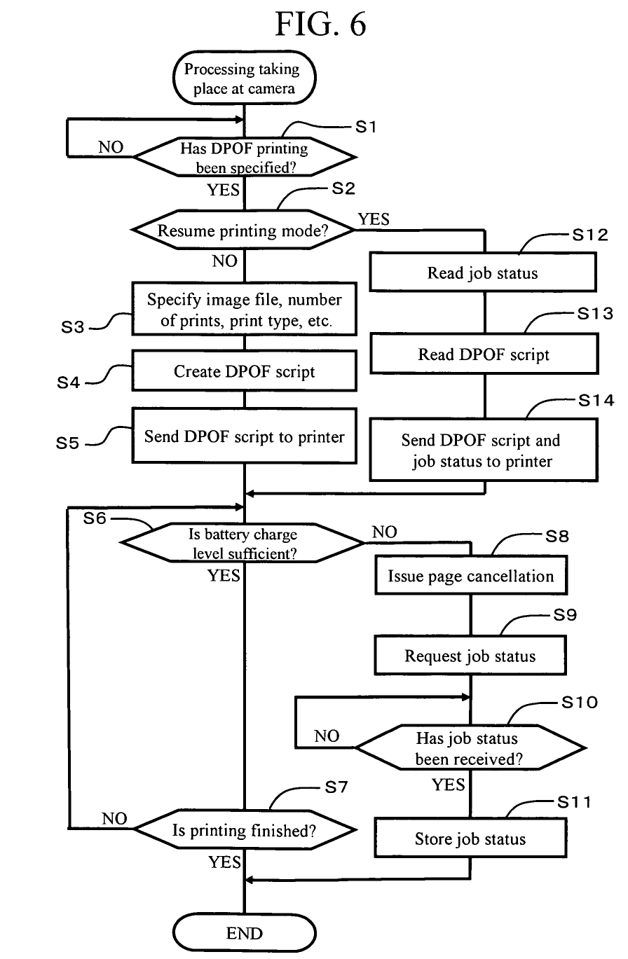

Next, referring to the respective flowcharts in FIGS. 6 through 8, printing system operation will be described. Hereinafter, “step” is abbreviated “S”. Note that flowcharts shown in the drawings indicate operations in schematic fashion, and may differ from actual programming.

First, FIG. 6 shows DPOF print specification processing such as might be executed at camera 10. The user specifies DPOF printing by way of user interface 14 (S1). Next, determination is made as to whether operations are being carried out pursuant to resume printing mode (S2); and upon specification of ordinary DPOF printing by the user (S2=NO), the user respectively specifies image(s) to be printed; number(s) of prints; print type(s); and the date, caption, and/or other text to be printed together therewith (S3). DPOF script file(s) is/are created based on the manner of printing and so forth specified by the user (S4). Camera 10 sends DPOF script file(s) to printer 20 via USB cable (S5).

As described below, printer 20 begins printing as requested by camera 10 based on received DPOF script file(s); and printer 20 monitors status of printing and creates job status information, which it communicates to camera 10.

Camera 10, if driven by internal battery, carries out monitoring to determine whether battery charge level is at or above a prescribed value (S6). In the event that battery charge level is at or above the prescribed value (S6=YES), processing continues until printing is completed (S7).

On the other hand, if battery charge level is below the prescribed value, power is shortly thereafter disengaged and camera 10 is made to enter standby mode and/or shutdown mode, making communication of data with printer 20 impossible and precluding continuation of printing (S6=NO).

Accordingly, in the event that battery charge level is low, a page cancellation request is issued to printer 20 (S8) with the purpose of requesting abortion of printing in prescribed units, and printer 20 is requested to reply by sending job status information (S9).

In addition, camera 10 waits for job status information to be communicated thereto from printer 20 (S10); and in the event that job status information is received, it is saved, overwriting as necessary (S11). Accordingly, stored at camera 10 there will be only a single set of job status information, this being the most recent version thereof which was being processed at the time that printing was interrupted. As a result, after finishing printing any page(s) currently being printed, printer 20 causes cancellation of print job(s) and terminates processing without printing any subsequent page(s).

Moreover, upon gaining access to electrical power necessary for continuation of printing as a result of having recharged battery or batteries, received supply of electricity from external power supply or supplies, or the like, it is possible for the user to resume the printing that had been interrupted.

In the event that DPOF printing is to be resumed (S2=YES), the job status information that was stored is read (S12), DPOF script file(s) is/are also read (S13), and the job status information and DPOF script file(s) are sent to printer 20 (S14). Thereafter, printing processing continues with battery charge level being monitored in the same fashion as described above.

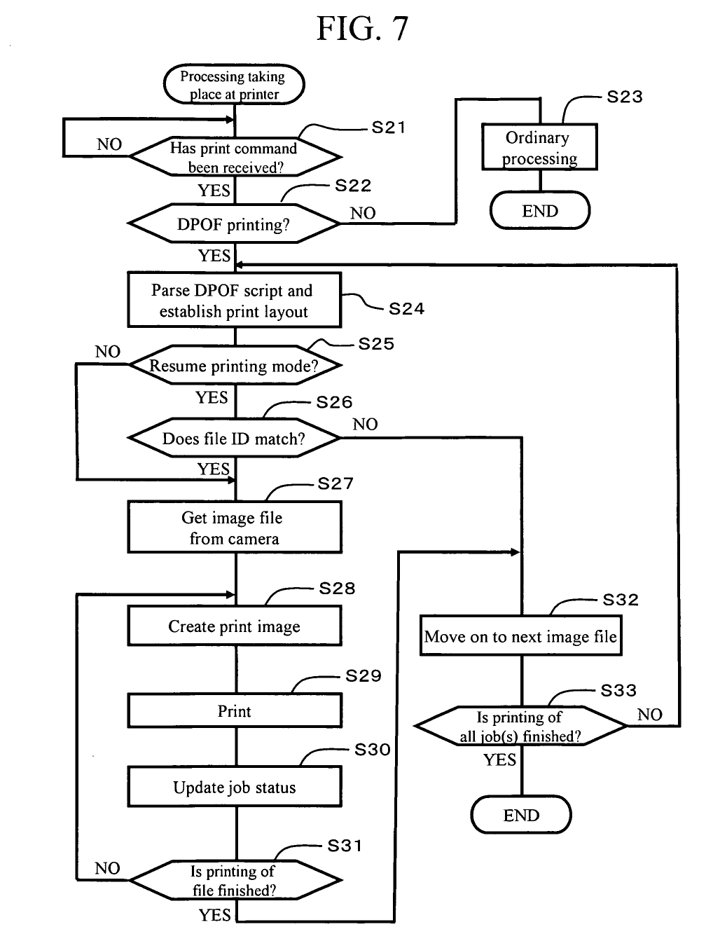

Next, FIG. 7 shows DPOF printing processing such as might be executed at printer 20. Printer 20 carries out monitoring to determine whether print command(s) has or have been entered from external equipment (S21); and in the event that print command(s) is/are received (S21=YES), determination is made as to whether such print command(s) is/are request(s) for DPOF printing, i.e., whether DPOF script file(s) has or have been received (S22). In the event that such command(s) is/are not DPOF printing command(s), ordinary processing is carried out in correspondence to such command(s) (S23). For example, where a print request is received from a personal computer, ordinary printing processing would be carried out.

In the event that such command(s) is/are for DPOF printing (S22=YES), DPOF script file(s) is/are parsed and print layout(s) is/are set (S24). Next, determination is made as to whether operations are being carried out pursuant to resume printing mode (S25). In the event that operations are being carried out pursuant to ordinary DPOF printing mode (S25=NO), image file(s) specified at job description section(s) of DPOF script file(s) is/are obtained from recording medium or media 12 (S27). Moreover, printer-ready image(s) is/are created (S28), and printing is begun (S29).

In the event that printing of new image file(s) is begun, job status information is updated (S30). The processing steps at S28 through S30 are repeated until printing of image file(s) is completed (S31). In the present embodiment, because serial printer(s) is/are employed, printer-ready image(s) is/are sequentially formed one band at a time, with printing being carried out in increments of a single pass or of multiple passes. In the event that the specified image file(s) has or have been printed the specified number of times (S31=YES), processing proceeds to any image file(s) to be printed subsequent thereto (S32), and determination is carried out with regard to whether all print job(s) has or have been printed (S33). The foregoing processing is repeated until all print job(s) has or have been printed.

Accordingly, with each new image file or set of image files that is printed, job status information is updated. Printer 20 updates job status information at appropriate time(s), and when print cancellation(s) is or are input thereto from camera 10, the most recent job status information is communicated to camera 10 and is stored thereat.

On the other hand, in the event that operations are being carried out pursuant to resume printing mode (S25=YES), DPOF script(s) and job status information are again sent from camera 10 to printer 20. In resume printing mode, DPOF script(s) is/are parsed, reading of DPOF script file(s) being advanced to print job(s) referencing image file(s) possessing file ID(s) matching file ID(s) indicated in the most recent job status information received from camera 10, and printing is resumed starting with the image file(s) having the matching file ID(s) (S26). In other words, printing is resumed beginning with image file(s) which was or were being printed when printing was interrupted due to print cancellation(s).

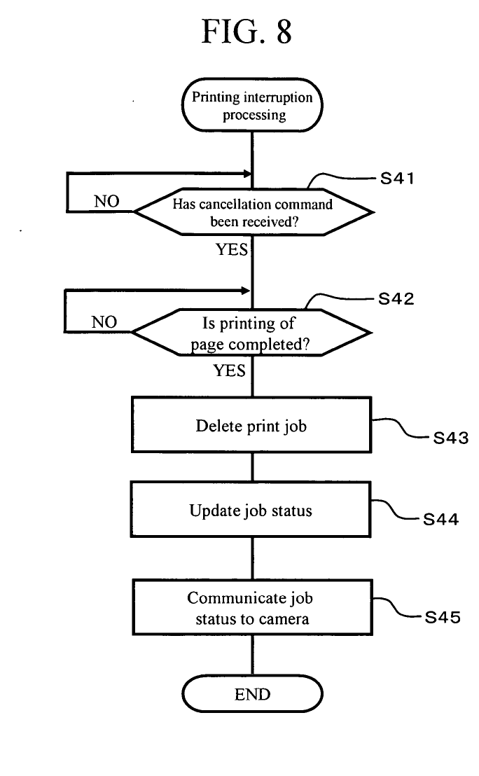

FIG. 8 shows printing interruption processing such as might be executed at printer 20. Printer 20 carries out monitoring to determine whether print cancellation command(s) (page cancellation command(s) in the event that cancellation is in units of pages) has or have been received from camera 10 (S41).

In the event that print cancellation command(s) has or have been received (S41=YES), printing processing is made to continue until printing of page(s) currently being printed has been completed (S42). Moreover, when printing of page(s) being printed has been completed, print job(s) is or are deleted (S43), job status information is updated (S44), and the updated most-recent job status information is communicated to camera 10 (S45). And in the case of interruption of printing in units of object(s), most recent job status information would be communicated to camera 10 after awaiting conclusion of printing of any object(s) currently being printed.

Here, job status information sent from camera 10 during resumption of printing may contain information identifying print job(s) (PRT PID), file ID(s), and number(s) of set(s) of prints to be printed (PRT QTY). Printer 20 parses job status information, resuming printing starting with unprinted portion(s) and avoiding repeated printing of portion(s) already printed.

Thus, when the paper jam or other such printing error has been eliminated at the printer, communication of such fact is sent from the printer to camera 10 or other such host apparatus(es). After receiving such communication, the host apparatus, responsive to manual operation(s) carried out by user(s) or automatically (i.e., without the need for any manual operation on the part of the user), may request that printer 20 automatically resume printing starting with any unprinted page(s).

Alternatively or in addition thereto, where printing error(s) has or have occurred due to reason(s) attributable to printer(s) (e.g., paper jam or the like), information for image file(s) currently being printed might be caused to be stored at host apparatus(es) as job status information; or conversely, where printing error(s) has or have occurred due to reason(s) attributable to host apparatus(es) (e.g., low battery level(s) at camera(s) 10), information for image file(s) currently being printed might be caused to be stored at printer(s) 20 as job status information. Moreover, in the latter case, when cause(s) of error(s) at host apparatus(es) has or have been eliminated (e.g., battery or batteries at camera(s) 10 have been recharged to adequate level(s)) and it is possible to resume printing, job status information stored at printer(s) 20 might be sent to host apparatus(es). After receiving such job status information from printer(s) 20, host apparatus(es) might request that printer(s) 20 automatically resume printing starting with any unprinted page(s).

In accordance with the present embodiment which is constituted in such fashion, it is possible for camera(s) to be apprised of most-recent printing status(es), and it is moreover possible for printing to be interrupted in prescribed unit(s) serving as convenient division(s), even in the context of DPOF printing in which image data is sent directly from peripheral equipment to printer(s) and printing is caused to be automatically carried out.

Accordingly, even where continuation of printing becomes impossible due to insufficient battery charge level or the like, printing can be interrupted in prescribed unit(s), making it possible to prevent printed output from going to waste. Furthermore, during resumption of printing, because repeated printing of portion(s) already printed does not occur, it is possible to prevent wasted consumption of printing paper, ink, and/or the like. Furthermore, because portion(s) which has or have already been printed are not printed, it is possible to decrease the time which the user spends waiting to obtain the final printed output.

Furthermore, where job status information is stored at camera(s) 10, this will make it possible, following recharging of internal battery or batteries 18, to resume printing of any remaining portion(s) simply by connecting camera(s) 10 to different printer(s) of identical or similar type. Accordingly, even where, for example, battery charge level becomes insufficient and printing is interrupted at one location during DPOF printing, DPOF printing can be resumed at another location to which transition is made, improving convenience.

In addition, where job status information is made up of the minimum amount of information required for resumption of printing and/or where file IDs are created from partial image file path information so as to reduce data size and/or where only the most recent job status information is stored, this will make it possible to reduce any burden associated with storing of job status(es) by camera(s).

Furthermore, in the present embodiment, because not only image file(s) and DPOF script(s) but also job status information is stored at recording medium or media 12, even where recharging or the like cannot be carried out immediately and/or there is failure of camera(s) 10 during interruption of printing, it is possible by installing recording medium or media 12 at different camera(s) of the same type to cause printing to be resumed beginning with interrupted image file(s).

Moreover, in the present embodiment, digital camera 10 need not know anything about page division(s) but need only send image file(s) requested therefrom by printer 20; and printer 20 converts image file(s) obtained from digital camera 10 into image data for printing in units of bands, and carries out printing in serial fashion. Here as well, in the event of request(s) for print cancellation, printer 20 may carry out printing in units of bands until printing of page(s) currently being printed has been completed; and following completion of printing of such page(s), may cancel printing of other page(s) subsequent thereto.

### 2. Second Embodiment

Next, FIG. 9 is a flowchart showing DPOF print instruction processing taking place at a camera, this being associated with a second embodiment of the present invention.

Characteristic of the present embodiment is the fact that, besides automatic interruption of printing due to consumption of internal battery or batteries 18 (S6), DPOF printing may be interrupted as a result of interruption instruction(s) from user(s) (S51).

### 3. Third Embodiment

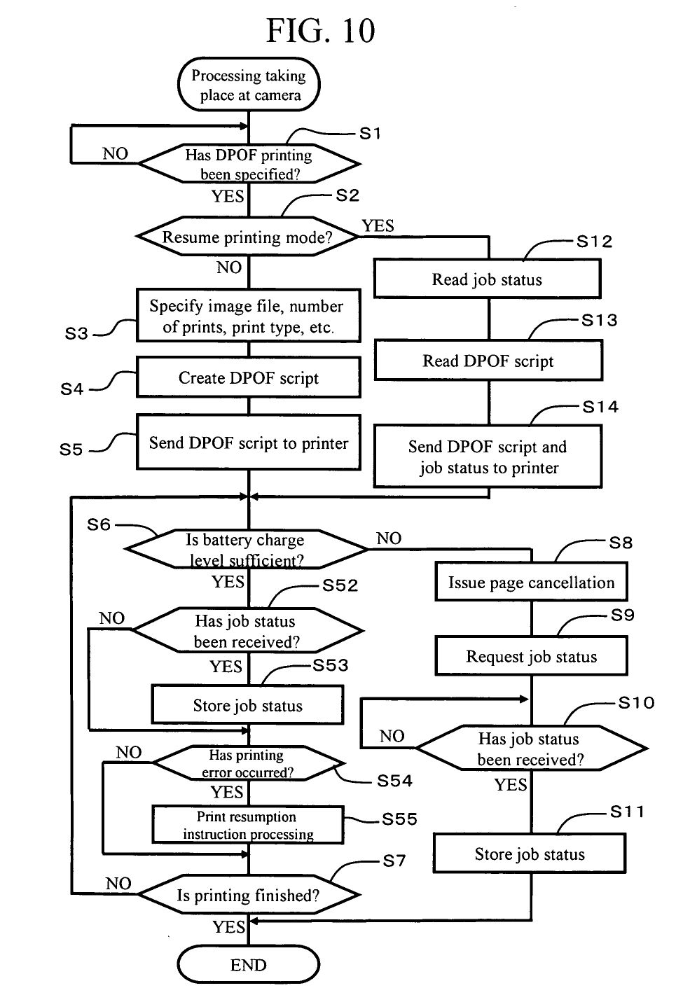

FIG. 10 is a flowchart showing DPOF print instruction processing which might take place at a camera in accordance with a third embodiment. Characteristic of the present embodiment is the fact that job status information is obtained from printer(s) 20 at appropriate times and is saved, overwriting as necessary (S52, S53), not only in anticipation of time(s) when printing is automatically interrupted due to battery consumption but also in anticipation of occurrence of printing error(s) at printer(s) (S54, S55).

By obtaining job status information from printer 20 at appropriate times, camera 10 can be kept apprised of the progress of printing at printer 20, and can, in the event of occurrence of printing error(s) at printer 20, carry out processing for resumption of printing (S55).

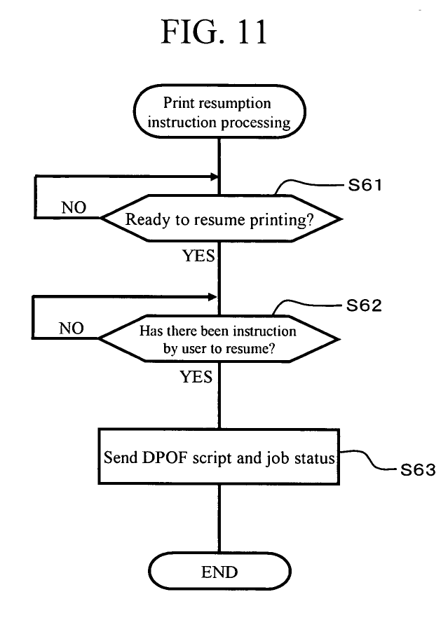

That is, as indicated at FIG. 11, if printing is interrupted for reason(s) attributable to printer(s) due to paper jam(s), depletion of ink(s), and/or the like, processing awaits completion of preparations to resume printing at printer 20 (S61); and in the event that preparations to resume printing have been completed, instruction to resume printing is first awaited from the user (S62), following which job status information and DPOF script file(s) are sent to printer 20, and printing is caused to be resumed (S63).

### 4. Fourth Embodiment

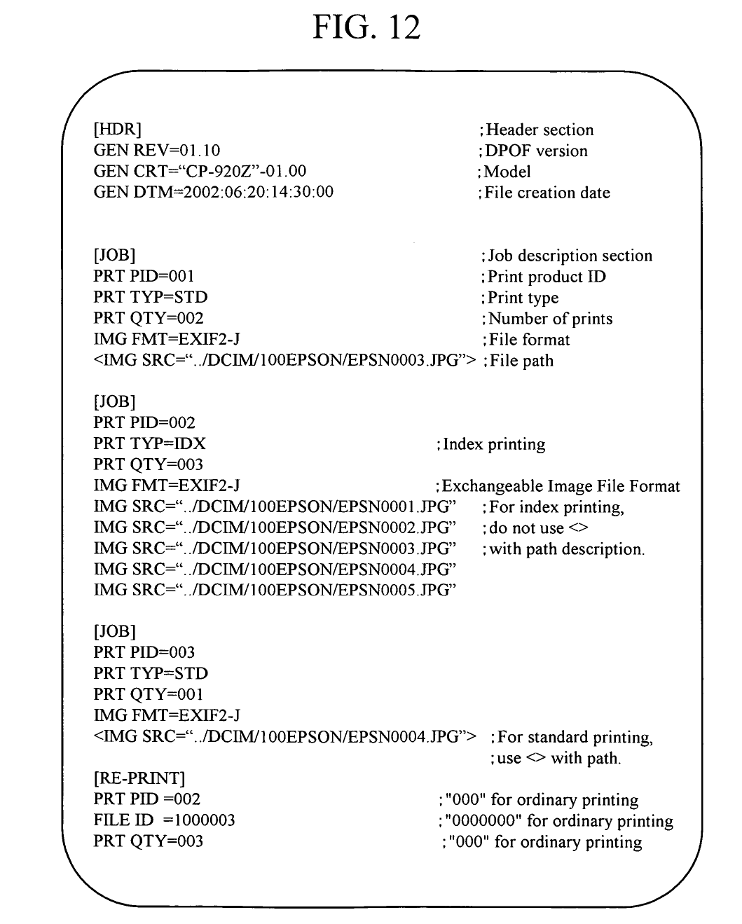

FIG. 12 shows a DPOF script file associated with a fourth embodiment. In the present embodiment, the DPOF script file contains description of job status information as indicated at “RE-PRINT”. Moreover, during ordinary printing, by setting the values of the various parameters present in the job status information to “000” it is possible to declare that this is ordinary printing.

Alternatively or in addition thereto, even at the foregoing respective embodiments in which job status information and DPOF script file(s) are created respectively separately but in mutually associated fashion, it is possible during ordinary printing to inform printer(s) of the fact that ordinary printing is being carried out by setting value(s) of parameter(s) in job status information to special code(s) (e.g., “000” or the like). By so doing, data sent from camera(s) 10 to printer(s) 20 may employ common type(s) and structure(s) regardless of whether processing is being carried out pursuant to normal printing mode or resume printing mode, permitting simplification of program structure.

### 5. Fifth Embodiment

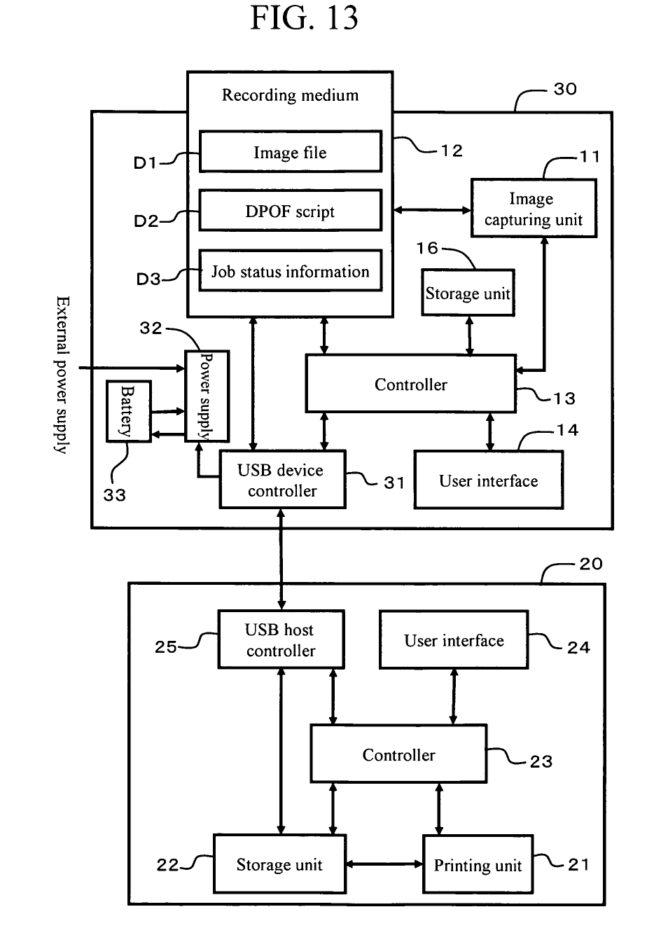

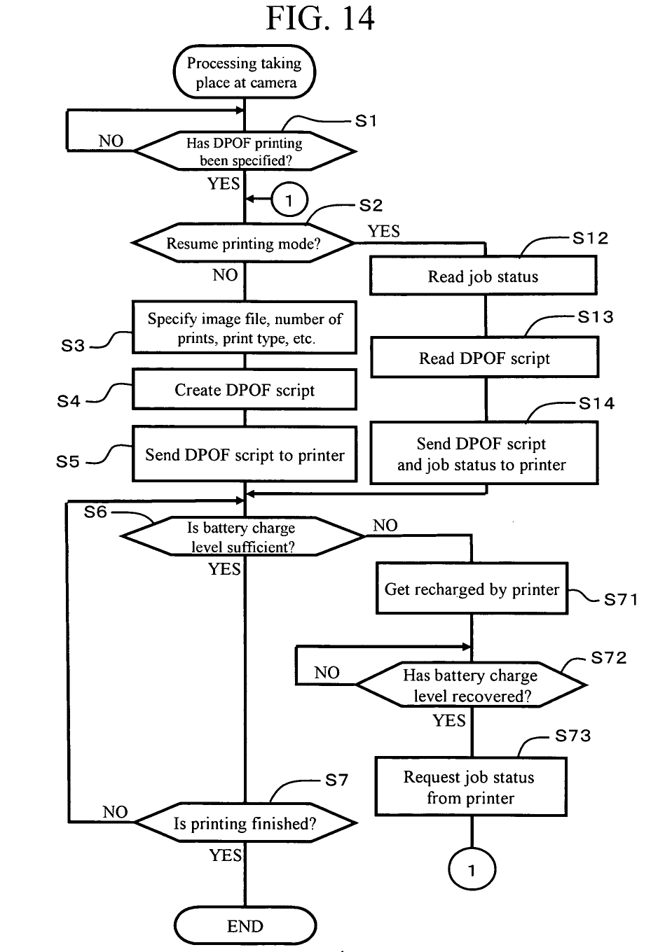

FIGS. 13 and 14 show a fifth embodiment. In the present embodiment, in the event that battery charge level(s) of battery or batteries 33 of camera(s) 30 decrease so as to be less than or equal to prescribed value(s), producing error(s), information for page(s) currently being printed may be stored at printer(s) 20 as job status information, and job status information may be sent from printer(s) 20 to camera(s) 30 when battery or batteries 33 has or have recovered due to supply of electricity from printer(s) 20.

Reference is now made to FIG. 13. Camera 30 might, for example, be constructed such that battery 33 is a compact battery or the like. Power supply unit 32 has circuit structure permitting battery 33 to be recharged by printer 20. For example, by utilizing USB bus power from printer 20, battery 33 could be recharged by way of USB device controller 31.

Reference is now made to FIG. 14. When battery charge level decreases (S6=NO), camera 30 gets printer 20 to recharge battery 33 (S71). At this time, job status information for job(s) being printed is stored at printer 20. In addition, when charge level at battery 33 recovers due to recharging by printer 20 (S72=YES), camera 30 obtains job status information from printer 20 (S73) and causes printing to be resumed (S2).

Thus, in the event that charge level(s) of battery or batteries 33 decrease, battery or batteries 33 may be recharged by printer(s), and printing may be automatically resumed when charge level(s) of battery or batteries 33 recover. Accordingly, there being no need for communication of cancellation(s) and there being no need to endure the inconvenience of having to recharge battery or batteries 33 of camera(s) 30 using special-purpose recharging equipment or the like, user-friendliness is improved. Recharging of battery or batteries 33 by printer(s) 20 is not limited to recharging which is accomplished through employment of USB bus power.

Moreover, the foregoing embodiments of the present invention have been presented as examples for purposes of describing the present invention and without intent to limit the scope of the present invention to those embodiments alone. One of ordinary skill in the art will be able to carry out the present invention in the context of a wide variety of other embodiments without departing from the essence of the present invention.

For example, camera(s) 10 and printer(s) 20 need not be connected via USB. For example, data communication may be carried out via IEEE 1394 interface, wireless LAN, infrared, and so forth.

1. In the context of a printing system comprising a host apparatus creating print data and a printer obtaining print data from the host apparatus and carrying out printing, a printing system characterized in that it comprises:
cancellation means for requesting cancellation of printing in units of pages; and
print control means for, in the event that cancellation of printing has been requested by the print cancellation means, causing printing to continue until printing of a page currently being printed is completed.

2. A printing method characterized in that it comprises:
a step in which print data is sent from a host apparatus to a printer;
a step in which printing is carried out at the printer based on the print data;
a step in which a cancellation of printing in units of pages is issued;
a step in which, in the event that the printing cancellation has been issued, determination is made as to whether printing of a page currently being printed at the printer is completed; and
a step in which, in the event that it is determined that printing of the page currently being printed is completed, printing processing is terminated.

3. A printing method according to claim 2 wherein the printing cancellation issuing step is such that determination is made as to whether a printing interruption event is expected to occur at the host apparatus, and in the event that the printing interruption event is expected to occur, the cancellation of printing in units of pages is issued.

4. A printing method according to claim 3 wherein the printing interruption event is indicative of circumstances causing or tending to cause the host apparatus to be unable to engage in data communication with the printer due to insufficient supply of electrical power to the host apparatus.

5. A printing method according to claim 2 wherein the printing cancellation issuing step is such that the cancellation of printing in units of pages is issued based on circumstances causing or tending to cause the host apparatus to be unable to engage in data communication with the printer.

6. A printing method according to claim 2 wherein the printing cancellation issuing step is such that the cancellation of printing in units of pages is issued in the event that a printing interruption instruction is input by a user.

7. A printer obtaining print data from a host apparatus and carrying out printing, the printer being characterized in that it comprises:
means for accepting a cancellation of printing in units of pages from the host apparatus; and
print control means for, in the event that the printing cancellation has been accepted, causing printing to continue until printing of a page currently being printed is completed.

8. A printer obtaining print data from a host apparatus and carrying out printing, the printer being characterized in that it comprises:
storage means for storing the print data obtained from the host apparatus;
print means for reading the stored print data, creating image data in units of bands, and printing;
means for accepting a cancellation of printing in units of pages from the host apparatus; and
print control means for, in the event that the printing cancellation has been accepted, causing printing to continue until printing of a page currently being printed is completed.

9. A host apparatus creating print data to be sent to a printer, the host apparatus being characterized in that it comprises:
print instruction means for sending the print data to the printer and causing printing; and
cancellation means for, in the event that a prescribed print cancellation condition exists, requesting cancellation of printing in units of pages at the printer such that printing continues until printing of a page currently being printed is completed.

10. A host apparatus according to claim 9 wherein the prescribed print cancellation condition is:
whether a battery charge level of an internal battery has decreased to a preestablished prescribed value; or
whether a user has issued a printing interruption instruction; or
whether a battery charge level of an internal battery has decreased to a preestablished prescribed value and a user has issued a printing interruption instruction.

11. A host apparatus according to claim 9 further comprising storage means for storing interruption location information obtained from the printer indicating a location at which printing was interrupted pursuant to the request for cancellation of printing;
wherein the prescribed print cancellation condition is whether a battery charge level of an internal battery has decreased to a preestablished prescribed value; and
the print instruction means, in the event that the battery charge level of the internal battery recovers to the extent that the prescribed value is exceeded, causes the interrupted printing to resume based on the stored interruption location information.

12. A host apparatus according to claim 9 wherein:
the prescribed print cancellation condition is whether a battery charge level of an internal battery has decreased to a preestablished prescribed value; and
the print instruction means, in the event that the battery charge level of the internal battery recovers to the extent that the prescribed value is exceeded, obtains, from the printer, interruption location information indicating a location at which printing was interrupted pursuant to the request for cancellation of printing, and causes the interrupted printing to resume based on this interruption location information.

13. A computer program for causing a computer to execute a method in which print data is obtained from a host apparatus and printing is caused to be carried out, the method comprising:
a step in which a cancellation of printing in units of pages is accepted from the host apparatus;
a step in which, in the event that the printing cancellation has been accepted, determination is made as to whether printing of a page currently being printed is completed; and
a step in which, in the event that it is determined that printing of the page currently being printed is completed, printing processing is terminated.

14. A computer program for causing a computer to execute a method in which print data is sent to a printer and printing is caused to be carried out, the method comprising:
a step in which the print data is sent to the printer and printing is caused to be carried out;
a step in which determination is made as to whether a prescribed print cancellation condition exists; and
a step in which, in the event that the prescribed print cancellation condition exists, a cancellation of printing in units of pages is issued to the printer such that printing continues until printing of a page currently being printed is completed.

15. In the context of a printing system comprising a host apparatus creating print data and a printer obtaining print data from the host apparatus and carrying out printing, a printing system wherein:
in the event that a battery charge level of the host apparatus is less than or equal to a prescribed value,
(1) job status information is stored at the printer;
(2) the battery is recharged using power from the printer;
(3) judgment is made as to whether the battery charge level has recovered to the extent that the prescribed value is exceeded; and
(4) in the event that the battery charge level recovers, the job status information is obtained from the printer and printing is continued.
